(19) United States
(12) Patent Application Publication
(10) Pub. No.: US 2005/0174754 A1
(43) Pub. Date: Aug. 11, 2005

(54) Flashlight pen and its combination

(76) Inventor: Te-Hsiang Fang, Taipei Hsien (TW)

Correspondence Address: TROXELL LAW OFFICE PLLC, Suite 1404, 5205 Leesburg Pike, Falls Church, VA, 22041, US

(21) Appl. No.: 10/790,130

(22) Filed: Mar. 2, 2004

(30) Foreign Application Priority Data
Feb. 5, 2004 (CN) 200420001256.6

(51) Int. Cl. B43K 29/10; F21L 4/04

(52) U.S. Cl. 362/118; 362/205

(57) ABSTRACT

The present invention discloses a flashlight pen and its combination, and the flashlight pen comprises a penholder being hollow on both ends and having a first accommodating space for accommodating a refill such that one end of the refill is exposed from a tip of the penholder for writing; a cap, being hollow at one end for capping the penholder and having a second accommodating space and at least one decorative strip; a decorative member, being coupled to another end of the cap; a flashlight device, being disposed in the second accommodating space for providing illumination through the decorative member; and a switch, being coupled to the flashlight device and exposed from the cap for turning on or off the flashlight device.

### FIELD OF THE INVENTION

The present invention relates to a flashlight pen, more particularly to a flashlight pen and its combination having a candle-shaped decorative strip and a torch-shaped cap, such that the flashlight pen emits a light from its torch-shaped cap.

### BACKGROUND OF THE INVENTION

At present, cultural and recreational items such as a flashlight pen, a mini flashlight, and a flashlight keychain are very popular in the market. These items generally have a battery inside and a press button for turning on and off the flashlight lamp to constitute a simple luminance circuit. When the press button is pressed, the circuit is switched on to light up the flashlight lamp. Further, such products may come with different stylish appearances to provide flashlight pens having the luminance function.

For example, the Taiwanese Patent Application No. 88204648 disclosed a flashlight pen, which installs a flashlight device in an opening at the rear end of a penholder, such that the LED of the flashlight device is exposed from the tip of the pen, and a transparent cap is coupled to the tip of the pen to show the LED.

In another example, the Taiwanese Patent Application No. 90204933 disclosed a mini flashlight having an illumination function, which comprises a front penholder and a rear penholder. A spring and a refill are disposed inside the front penholder and a flashlight module and a push switch module are disposed inside the rear penholder; wherein the flashlight module is disposed at the tip of the refill and the push switch module is disposed on the flashlight module.

However, these prior-art flashlight pens have shortcomings of just being a flashlight pen with illumination function only, and not having the decorative effect. When the push button is pressed to switch on the circuit, the flashlight is lit. Such products do not come with different stylish appearances and cannot meet the customer's requirements for a refined flashlight pen souvenir.

In view of the shortcomings of the foregoing prior arts, the inventor of this invention based on years of experience on stationery design and marketing to conduct researches and experiments to overcome the foregoing shortcomings of the flashlight pen, and finally invented the “Flashlight pen and its combination” in accordance with this invention.

### SUMMARY OF THE INVENTION

The primary objective of the present invention is to overcome the deficiencies of the present technology by providing a flashlight pen with illumination function and decorative function.

To achieve the objective of this invention, the flashlight pen comprises a penholder being hollow on both ends and having a first accommodating space for accommodating a refill such that one end of the refill is exposed from a tip of the penholder for writing; a cap, being hollow at one end for capping the penholder and having a second accommodating space and at least one decorative strip; a decorative member, being coupled to another end of the cap; a flashlight device, being disposed in the second accommodating space for providing illumination through the decorative member; and a switch, being coupled to the flashlight device and exposed from the cap for turning on or off the flashlight device.

Another objective of this invention is to provide a flashlight pen and its combination having a decorative function to overcome the shortcoming of the present technology.

To achieve the foregoing objective of this invention, the flashlight pen combination comprises a flashlight pen, at least one penholder, a cap, a flashlight device, a switch, and at least one decorative strip for tying a decorative member; wherein the decorative strip is coupled to the cap, and the decorative member is coupled to one side of the cap, and a guide channel is disposed at a base and has a size for precisely accommodating the penholder, so that when the penholder of the flashlight pen is inserted into the guide channel, the decorative strip is exposed precisely from the base and the light of the flashlight device is emitted through the decorative member for the illumination purpose.

The present invention adopts the foregoing structure, such that when the flashlight pen is lit, the torch-shaped decorative emits a blinking light. The appearance of the flashlight pen looks like a lit candle. In addition to the illumination effect, the present invention also has the decorative effect to satisfy different customer's requirements.

### BRIEF DESCRIPTION OF THE DRAWINGS

FIG. 1 is a view of the combination of the flashlight pen according to a preferred embodiment of the present invention.

FIG. 2 is a view of the flashlight device according to a preferred embodiment of the present invention.

FIG. 3 is a view of the combination of the flashlight pen according to another preferred embodiment of the present invention.

FIG. 4 is a view of the combination of the flashlight pen according to another further preferred embodiment of the present invention.

### DETAILED DESCRIPTION OF THE PREFERRED EMBODIMENTS

To make it easier for our examiner to understand the objective of the invention, its structure, innovative features, and performance, we use a preferred embodiment together with the attached drawings for the detailed description of the invention.

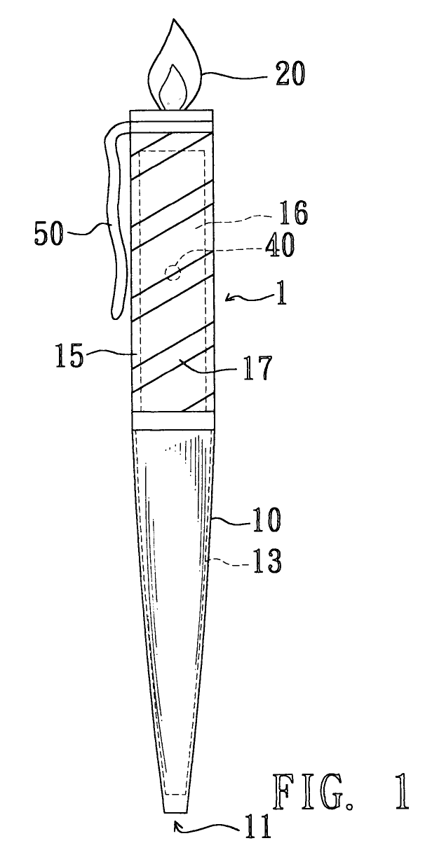

Please refer to FIG. 1 for the flashlight pen combination of a preferred embodiment of the present invention. In the figure, the flashlight pen comprises a penholder 10, a cap 15, a decorative member 20, a flashlight device 30, and a switch 40.

The penholder 10 is hollow on both ends 11, 12, and has a first accommodating space 13 for accommodating a refill (not shown in the figure), and the refill is protruded from a tip 11 of the penholder 10 for writing. The cap 15 has a second accommodating space 16, and the appearance of the cap 15 comes with at least one decorative strip 17. The shape of the decorative strip 17 includes but not limited to a candle shape, which surrounds the cap 15, and is preferably made by spraying a red paint on the appearance of the cap.

The decorative member 20 is coupled on the cap 15, and has a shape including but not limited to a torch shape, and made of a transparent material and sprayed with a red paint, so that the decorative member 20 is coupled onto one side of the cap 15 and its appearance looks like a candle-shaped torch.

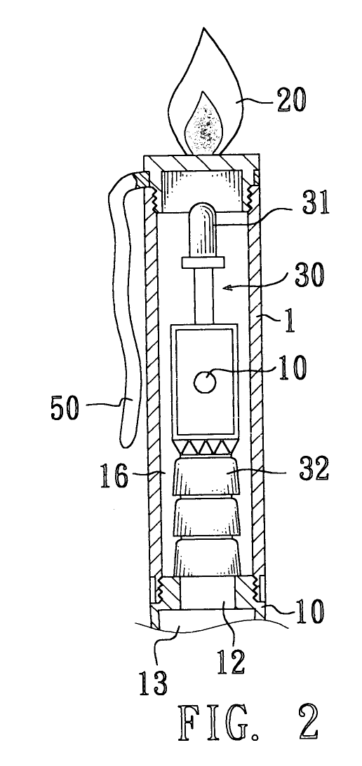

Please refer to FIG. 2 for the view of the flashlight device 30 according to the present invention. In the figure, the flashlight device 30 of the invention is disposed in the second accommodating space 16 and further comprises a LED 31 and a battery 32, and the LED 31 is coupled to the battery 32 and the switch 40. When the switch 40 is pressed, the LED 31, battery 32, and switch 40 are electrically connected, so that the LED 31 will be lit. The light passes through the decorative member 20 to emit a light including but not limited to a blinking light for the illumination. The switch including but not limited to a press button is coupled to the flashlight device 30 and exposed out of the cap 15 for turning on or off the flashlight device 30. In addition, the flashlight pen 1 of the invention further comprises a pen clip 50 for being connected at a position between the decorative member 20 and the cap 15 for holding the flashlight pen 1 into a fixed position, and the pen clip 50 can also be sprayed with a red paint, such that the decorative strip 17, the decorative member 20, and the pen clip 50 are of the same color to improve the overall artistic look.

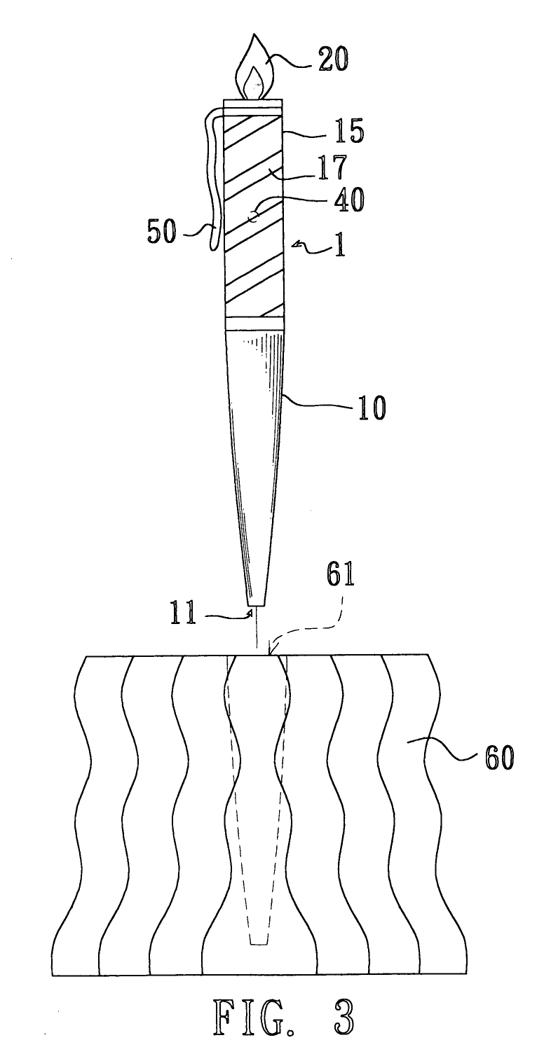

Please refer to FIG. 3 for the flashlight pen combination according to another preferred embodiment of the present invention. In the figure, the flashlight pen 1 of the invention can be combined with a base 60 to form a combination of flashlight pen 1. The structure of the flashlight pen 1 is the same as the one depicted in FIG. 1, which comprises at least one pen holder 10, a cap 15, a flashlight device 30, a switch 40, at least one decorative strip 17, and a decorative member 20, wherein the decorative strip 17 is installed on the cap 15, and the decorative member 20 is coupled onto one side of the decorative strip 17, and the appearance of the base 60 looks like a cake and has a guide channel 61 at the center for precisely accommodating the insertion of the penholder 10. Please refer to FIG. 1 for the principle of the flashlight pen 1, and thus it will not be described further. When the penholder 10 of the flashlight pen 1 is inserted into the guide channel 61, the candle-shaped decorative strip 17 will be exposed from the cake-shaped base 60, which looks exactly like having a candle on the cake. When the switch 40 is pressed, the flashlight device 30 will emit light including but not limited to a blinking light through the torch-shaped decorative member 20 for the illumination.

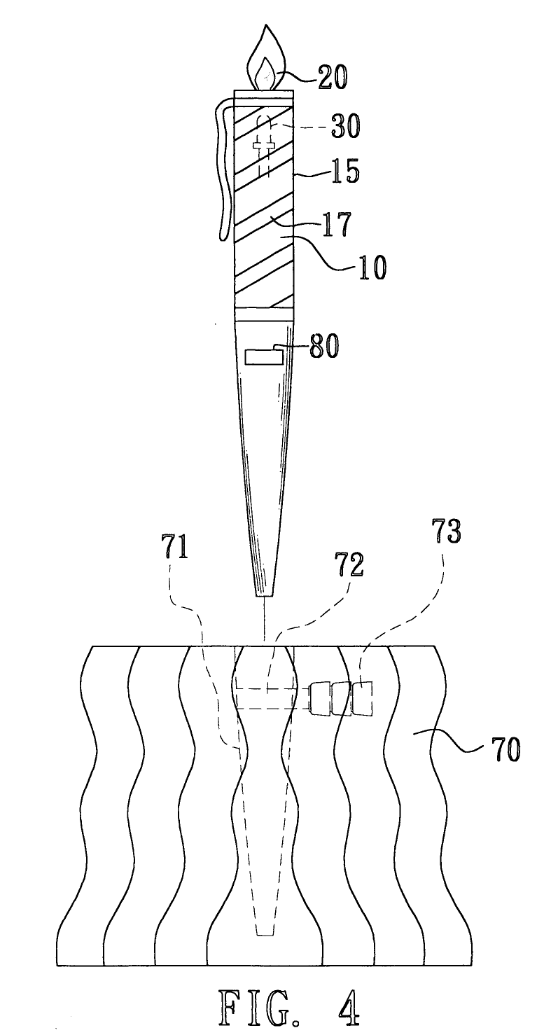

Please refer to FIG. 4 for the combination of the flashlight pen 1 according another preferred embodiment of the present invention. In the figure, the flashlight pen 1 of the invention is combined with a base 70 to form a combination of the flashlight pen. Most parts of the structure of the flashlight pen 1 are similar to those depicted in FIG. 1. The flashlight pen 1 comprises a pen holder 10, a cap 15, a flashlight device 30, a switch 80, at least one decorative strip 17, and a decorative member 20, wherein the decorative strip 17 is installed on the cap 15, and the decorative member 20 is connected onto one side of the decorative strip 17, and a base 70 looking like a cake and having a guide channel 71 at the center, such that the guide channel 71 precisely accommodates the insertion of the penholder 70. The flashlight pen 1 also has a circular conductive member 72 and a battery 73, wherein the circular conductive member 72 is disposed in the guide channel 71 for electrically coupled to the battery 73. The switch 80 including but not limited to a contact-type press button. When the flashlight pen 1 is inserted into the base 70, the switch 80 is in contact with the circular conductive member 72, such that the battery 73 supplies power to the flashlight device through the circular conductive member 72 and the switch 80, and the flashlight device 30 emits a light including but not limited to a blinking light for the illumination through the torch-shaped decorative member 20. Please refer to FIG. 1 for the principle of the flashlight pen 1, and thus it will not be described further.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

1. A flashlight pen, comprising:
a penholder, being hollow on both ends, and having a first accommodating space for accommodating a refill, and said refill being protruded from a tip of said penholder for writing;
a cap, being hollow at one end and coupled to said penholder, and said cap having a second accommodating space, and at least one decorative strip;
a decorative member, being coupled onto another end of said cap;
a flashlight device, being disposed in said second accommodating space and emitting light for illumination through said decorative member; and
a switch, being coupled to said flashlight device and exposed out of said cap for selectively turning on and off said flashlight device.

2. The flashlight pen of claim 1, further comprising a pen clip coupled to a position between said decorative member and said cap for holding said flashlight pen into a fixed position, and said pen clip being sprayed with a red paint.

3. The flashlight pen of claim 1, wherein said decorative strip candle-shaped and preferably sprayed with a red paint, and said decorative member is torch-shaped and preferably made of a transparent material and its surface being sprayed with a red paint.

4. The flashlight pen of claim 1 further comprising an LED and a battery, such that said flashlight device controls the LED to emit a blinking light through said decorative member.

5. The flashlight pen of claim 1, wherein said switch is a press button.

6. A flashlight pen combination, comprising:
a flashlight pen, at least one penholder, a cap, a flashlight device, a switch, at least one decorative strip, and a decorative member; wherein said decorative strip being installed onto said cap, and said decorative member coupled to one side of said cap; and
a base, having a guide channel with a size precisely accommodating the insertion of said penholder, such that when said flashlight pen is inserted into said guide channel, said decorative strip is exposed precisely from the base, and allows said flashlight pen to emit light through said decorative member for illumination.

7. The flashlight pen combination of claim 6, wherein said penholder is hollow on both ends, and has a first accommodating space for accommodating a refill, and said refill is protruded from a tip of said penholder for writing; and said cap is hollow at one end and coupled to said penholder, and said cap has a second accommodating space for accommodating said flashlight device.

8. The flashlight pen combination of claim 6 further comprising a pen clip for being coupled between said decorative member and said cap to hold said flashlight pen, and said pen clip being sprayed with a red color.

9. The flashlight pen combination of claim 6, wherein said decorative member is preferably candle-shaped, and said decorative member at said cap is sprayed with a red paint, and said decorative member is torch-shaped and preferably made of a transparent material and sprayed with a red paint.

10. The flashlight pen combination of claim 6, wherein said base is in the shape of a cake.

11. The flashlight pen combination of claim 6, wherein said switch is a press button, and said flashlight device further comprises an LED and a battery, wherein said battery is disposed in said cap and coupled to said LED, so that when said flashlight pen is inserted into said base, the flashlight pen controls said LED to emit a blinking light through said decorative member for illumination.

12. The flashlight pen combination of claim 6, wherein said switch is a contact-type switch, and said flashlight device further comprises an LED, and said base further comprises a circular conductive member and a battery, wherein said circular conductive member is disposed in said guide channel and said circular conductive member is coupled to said battery, such that when said flashlight pen is inserted into said base, said contact-type switch is in contact with said circular conductive member and said flashlight pen emits a light for illumination through said decorative member when said flashlight pen is inserted to said base, and thus said flashlight device controls said LED to emit a blinking light through said decorative member.
